(19) United States
(12) Patent Application Publication
(10) Pub. No.: US 2010/0244302 A1
(43) Pub. Date: Sep. 30, 2010

(54) METHOD OF MANUFACTURING CONNECTOR

(75) Inventors: Yoshinori OKUNO, Kariya-city (JP); Jun Kondo, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/750,087

(22) Filed: Mar. 30, 2010

(30) Foreign Application Priority Data
Mar. 31, 2009 (JP) 2009-085945

(51) Int. Cl. B29C 45/17

(52) U.S. Cl. 264/138

(57) ABSTRACT

A connector is manufactured by integrally molding with a resin, by using a first molding die having a molding portion for molding outer shapes of first and second connection portions of the connector, and a cylindrical second molding die inserted into the molding portion to mold an insertion hole in which a connection member is inserted. In the molding, a circular core portion is inserted into the molding portion in a state where the second molding die is inserted into the core portion. Then, the molded first and second connection portions are removed together with the core portion, from the first and second molding dies. Thereafter, the core portion in the first connection portion is dissolved by using a solvent, so that a circular recess portion for arranging an O-ring is formed to be recessed from a peripheral surface of the insertion hole to a radial outside.

### CROSS REFERENCE TO RELATED APPLICATION

This application is based on Japanese Patent Application No. 2009-085945 filed on Mar. 31, 2009, the contents of which are incorporated herein by reference in its entirety.

### FIELD OF THE INVENTION

The present invention relates to a method of manufacturing a connector adapted as a connection portion of a fluid pipe.

### BACKGROUND OF THE INVENTION

European patent No. 1394402A2 describes regarding a connector adapted as a connection portion between an injector and a low pressure fuel pipe in a fuel injection device. The connector is provided with a cylindrical insertion hole, and a cylindrical connection member provided at a low-pressure fuel outlet port of the injector is inserted into the insertion hole of the connector. Furthermore, a cylindrical insertion portion provided in the connector is inserted into an end portion of the low pressure fuel pipe, so that the injector and the low pressure fuel pipe are connected by using the connector.

In the connector structure described in European patent No. 1394402A2, it is necessary to liquid-tightly seal a clearance between an inner peripheral surface of the connector defining the insertion hole, and an outer peripheral surface of the insertion member of the injector. The O-ring may be fitted onto an outer peripheral surface of the connection member of the injector, and then the connection member may be inserted into the insertion hole of the connector together with the O-ring. In this case, before the connection member is assembled to the connector, the O-ring is exposed to exterior, and thereby the O-ring may be easily damaged while a connection operation between the connector and the connection member of the injector is performed.

To overcome the above problem, the O-ring may be attached into the inner peripheral surface of the connector defining the insertion hole. In this case, a circular recess portion for arranging the O-ring is provided in the inner peripheral surface of the connector defining the insertion hole, so as to prevent a detachment of the O-ring. Because the circular recess portion for receiving the O-ring is provided in the connector to be recessed from the peripheral surface of the insertion hole to a radial outside, it is difficult to integrally mold the connector.

The circular recess portion to be provided in the insertion hole of the connector will become in an undercut shape in a molding, and thereby a molded connector is difficult to be removed from a molding die.

On the other hand, if the connector is molded by dividing plural parts, it is necessary to assemble the plural pars, thereby increasing assemble steps and increasing product cost.

### SUMMARY OF THE INVENTION

In view of the foregoing problems, it is an object of the present invention to provide a method of manufacturing a connector, which can easily integrally form the connector having a recess portion for arranging an O-ring.

According to an aspect of the present invention, in a method of manufacturing a connector that includes a first connection portion to be connected to a connection member in which a fluid flows and a second connection portion to be connected to a pipe member in which the fluid flows, the first and second connection portions are integrally molded with a resin, by using a first molding die having a molding portion for molding outer shapes of the first and second connection portions, a cylindrical second molding die inserted into the molding portion of the first molding die to mold a cylindrical insertion hole in which the connection member is inserted, and a circular core portion inserted into the molding portion together with the second molding die in a state where the second molding die is inserted into the core portion. Then, the first and second molding dies are separated from each other so as to remove the molded first and second connection portions together with the core portion, from the first and second molding dies, after the integrally molding. Thereafter, the core portion in the first connection portion is dissolved by using a solvent, so as to form a circular recess portion for arranging an O-ring. Here, the recess portion is recessed from a peripheral surface of the insertion hole to a radial outside in the first connection portion. Accordingly, the recess portion for arranging the O-ring can be easily integrally formed in the connector.

For example, the solvent may be a strong acid liquid. In this case, the core portion can be made of a material of aluminum or iron. Alternately, the solvent may be a strong alkali liquid. In this case, the core portion can be made of a material of aluminum.

Furthermore, the second molding die may include a cylindrical portion extending in an axial direction and inserted into a hole portion of the core portion at a position in the axial direction. In this case, the core portion can be easily inserted into the molding portion of the first molding die together with the cylindrical portion of the second molding die, before the molding.

In addition, the molding portion of the first molding die for molding the outer shapes of the first and second connection portions may include a first molding part and a second molding part which are dividable from each other in the axial direction, at a position where the second connection portion is formed.

### BRIEF DESCRIPTION OF THE DRAWINGS

Additional objects and advantages of the present invention will be more readily apparent from the following detailed description of preferred embodiments when taken together with the accompanying drawings. In which:

FIG. 1 is a schematic diagram of a fuel injection device according to an embodiment of the invention;

FIG. 2 is a schematic cross-sectional view showing an injector in the fuel injection device of FIG. 1;

FIG. 3A is a top view showing a connection structure between a connection member of the injector and a low-pressure fuel pipe, and FIG. 3B is a cross-sectional view of the connection structure of FIG. 3A, according to the embodiment;

FIG. 4 is a disassembled perspective view showing the connection structure of FIGS. 3A and 313;

FIG. 5A is a cross-sectional view showing a release state of the connection structure in FIGS. 3A and 3B, and FIG. 5B is a cross-sectional view showing a lock state of the connection structure in FIGS. 3A and 3B; and

FIG. 6 is a schematic disassembled view showing a molding die for molding the connector according to the embodiment.

### DETAILED DESCRIPTION OF THE PREFERRED EMBODIMENTS

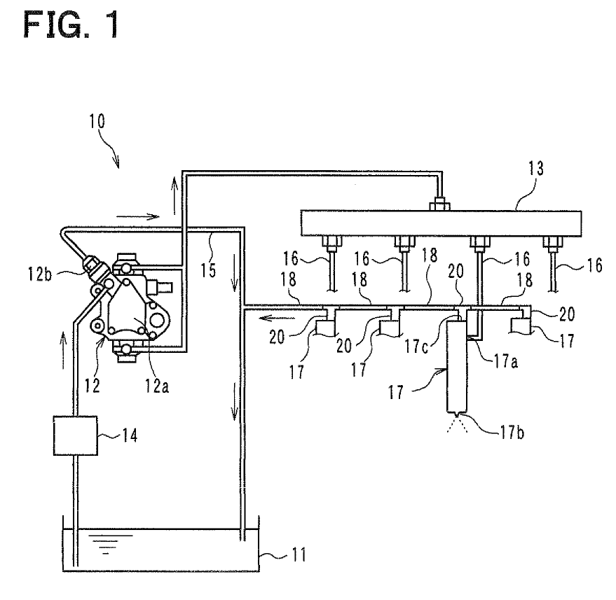

An embodiment of the present invention will be now described with reference to FIGS. 1 to 6. FIG. 1 is a schematic diagram showing an accumulator-type fuel injection device 10 that is typically used for a diesel engine in the present embodiment. The fuel injection device 10 is configured to inject fuel (fluid) stored in a fuel tank 11 into respective cylinders of an internal combustion engine. As the fuel, a diesel oil or a bio-fuel or the like may be used. The bio-fuel may include an alcohol fuel made of a vegetal material, and the like. The fuel in the fuel tank 11 is supplied to a common rail 13 by a fuel supply pump 12. A fuel filter 14 is located between the fuel tank 11 and the fuel supply pump 12.

The fuel supply pump 12 includes a feed pump portion (not shown), and a high-pressure pump portion 12a. The feed pump portion is adapted to draw fuel from the fuel tank 11 and to supply the drawn fuel to the high-pressure pump portion 12a. The high-pressure pump portion 12a pressurizes the fuel supplied from the feed pump portion, and sends the pressurized fuel to a common rail 13. The feed pump portion and the high-pressure pump portion 12a may be driven by an internal combustion engine or an electrical pump.

The high-pressure pump portion 12a is provided with a pressure adjustment valve 12b (overflow adjustment valve) which causes the fuel in the fuel tank 11 to flow out when a pressure in the pump 12 is more than a predetermined pressure. The fuel adjustment valve 12b is connected to the fuel tank 11 via a fuel return pipe 15.

The common rail 13 is configured as an accumulator in which the fuel pressurized in the high-pressure pump portion 12a can be maintained at a high pressure, and is connected to a fuel introduction port 17a of an injector 17 via a high-pressure fuel pipe 16. Generally, a plurality of the injectors 17 (e.g., four) and high-pressure fuel pipes 16 are provided to correspond to the plural cylinders of the internal combustion engine, respectively.

The high-pressure fuel accommodated in the common rail 13 is supplied to the injectors 17 via the high-pressure fuel pipes 16, and is injected into respective cylinders of the internal combustion engine via injection holes 17b of the injectors 17. Each of the injectors 17 is controlled by a controller to be opened for a predetermined time at a predetermined timing.

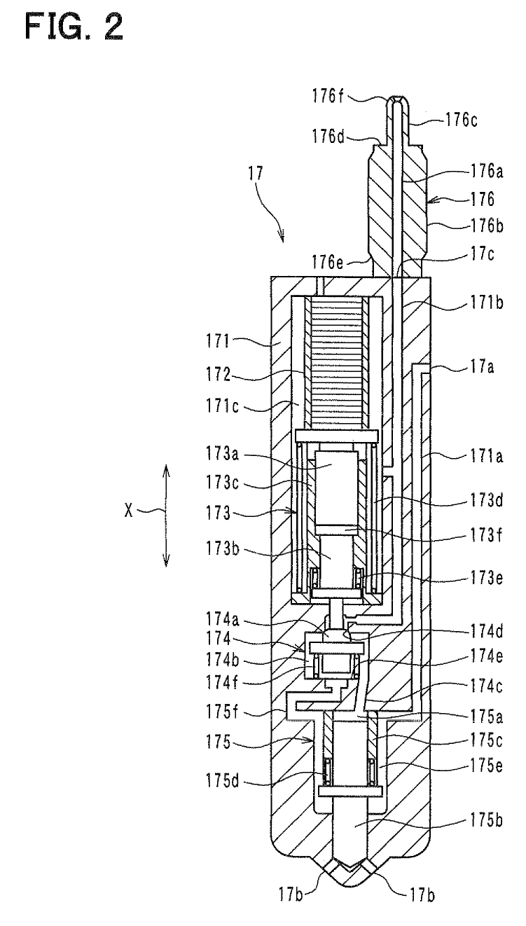

The injector 17 is provided with a fuel flow-out port 17c from which overflow fuel (i.e., leak fuel) flows out. The fuel overflowing from the injector 17 is, for example, a surplus fuel which is not injected from the injector 17 in the fuel supplied from the common rail 13 to the injector 17, or a fuel discharged from a control chamber 175a inside of the injector 17 shown in FIG. 2.

A low pressure fuel pipe 18 is connected to the respective fuel flow-out ports 17c. The leak fuel flowing out from the fuel flow-out port 17c to the low pressure fuel pipe 18 is returned to the fuel tank 11 together with the fuel flowing through the fuel return pipe 15. A connector 20 is located at each connection portion between the fuel flow-out port 17c and the low pressure fuel pipe 18.

FIG. 2 is a cross-sectional view showing one example of the injector 17. The injector 17 includes a piezo actuator 172, a drive power transmission portion 173, a control valve portion 174 and a nozzle portion 175, which are accommodated inside of an approximately cylindrical injector body 171. The piezo actuator 172, the drive power transmission portion 173, the control valve portion 174 and the nozzle portion 175 are arranged in this order in an axial direction X of the injector body 171, as shown in FIG. 2.

The fuel introduction port 17a for introducing high-pressure fuel from the common rail 13 is opened at a side wall of the injector body 171. The injection ports 17b for injecting high-pressure fuel are opened at a tip end portion of the injector body 171 on a side of the nozzle portion 175 (e.g., a lower end side of FIG. 2).

The fuel flow-out port 17c for flowing out of the leak fuel is provided at an end surface of the injector body 171 on a side of the piezo actuator 172 (e.g., an upper side of FIG. 2). The connector 20 and a connection member 176 are disposed at a position of the injector body 171, where the fuel flow-out portion 17c is provided.

A high pressure passage 171a is provided in the injector body 171 to communicate with the fuel introduction port 17a. The high pressure passage 171a is provided in the injector body 171 to extend in the axial direction X. A low pressure passage 171b is provided in the injector body 171 to communicate with the fuel flow-out portion 17c, and extends in parallel with the high pressure passage 171a in the axial direction X.

A receiving space 171c, in which the piezo actuator 172 and the drive power transmission portion 173 are received, is provided in the injector body 171. The low pressure passage 171b is provided in the injector body 171 to communicate with the receiving space 171c. The piezo actuator 172 is actuated by a drive circuit (not shown), and is configured to extend or contract in the axial direction X.

The drive power transmission portion 173 includes first and second pistons 173a, 173b movable integrally with the piezo actuator 172, a cylindrical member 173c which slidably hold the first and second pistons 173a, 173b, a first spring 173d which causes the first piston 173a to be biased toward the piezo actuator 172 so as to contact the piezo actuator 172, and a second spring 173e which causes the second piston 173b to be biased toward the control valve 174a of the control valve portion 174. An oil chamber 173f, in which an operation oil (e.g., fuel in the present embodiment) is filled, is provided between the first and second pistons 173a, 173b.

The control valve portion 174 includes a control valve 174a configured as a three-way valve, which is accommodated in a valve chamber 174b. The valve chamber 174b is made to generally communicate with the control chamber 175a of the nozzle portion 175 via a communication passage 174c.

The control valve 174a is configured to be movable integrally with the second piston 173b of the drive power transmission portion 173. The valve chamber 174b is provided with a low-pressure side seat surface 174d and a high-pressure side seat surface 174e on which the control valve 174a is selectively seated.

A communication port communicating with the low pressure passage 171b is open in the low-pressure side seat surface 174d. A communication port communicating with the high pressure passage 171a via the communication passage 175f of the nozzle portion 175 is open in the high-pressure side seat surface 174e. A spring 174f is disposed to cause the control valve 174a to be biased toward the second piston 173b of the drive power transmission portion 173 so that the control valve 174a contacts the second piston 173b.

When the piezo actuator 172 extends or contracts, the first and second pistons 173a, 173b of the drive power transmission portion 173 and the control valve 174a of the control valve portion 174 displace in the axial direction X, so that the control valve 174a can be selectively seated on the low-pressure side seat surface 174d or the high-pressure side seat surface 174e. Thus, the pressure in the control chamber 175a of the nozzle portion 175 can be increased or decreased.

The nozzle portion 175 includes a nozzle needle 175b extending in the axial direction X, a cylinder member 175c arranged at an outer peripheral side of the nozzle needle 175b, and a needle spring 175d causing the nozzle needle 175b to be biased to a side of the injection holes 17b.

The control chamber 175a of the nozzle portion 175 is defined by using an end surface of the nozzle needle 175b on a side of the valve chamber 174b and an end surface of the cylinder member 175c. The control chamber 175a is made to generally communicate with the valve chamber 174b of the control valve 174, so as to generate a back pressure to the nozzle needle 175b. The back pressure of the control chamber 175a is adapted to cause the nozzle needle 175b to be biased in a valve-close direction together with the needle spring 175d.

An oil storage chamber 175e, communicating with the high pressure passage 171a and the injection holes 17b, is provided at an outer peripheral side of the nozzle needle 175b and the cylinder member 175c. The oil storage chamber 175e communicates with a communication port of the high-pressure side seat surface 174e of the control valve portion 174 via a communication passage 175f. The oil storage chamber 175e is provided such that the pressure of the high-pressure fuel of the oil storage chamber 175e causes the nozzle needle 175b to be biased in a valve-open direction.

FIG. 2 shows a non-injection state of the injector 17. In the non-injection state of the injector 17, the nozzle needle 175b can be seated by the back pressure of the control chamber 175a and the biasing force of the needle spring 175d. Therefore, a fuel supply from the oil storage chamber 175e to the injection holes 17b is shut.

In contrast, in an injection state of the injector 17, the piezo actuator 172 is extended, and thereby the pressure of the control chamber 175a of the control valve portion 174 is reduced. Thus, the nozzle needle 175b moves upwardly against to the biasing force of the needle spring 175d of the nozzle needle 175b, so that the fuel stored in the oil storage chamber 175 is injected from the injection holes 17b.

The connection member 176 of the injector 17 is formed into approximately a cylindrical shape extending in the axial direction X, and is made of a stainless or a carbon steel. One end portion (e.g., a lower end portion) of the connection member 176 is fixed to the injector body 171 at a position where the fuel flow-out port 17c is formed. The connection member 176 and the injector body 171 can be fixed by screwing, fitting, resinous bonding, a melting or the like.

A fuel passage 176a communicating with the fuel flow-out port 17c of the injector body 171 is provided within the connection member 176. The connection member 176 includes a large outer diameter portion 176b on a side of the injector body 171 (e.g., the lower side in FIG. 2), and a small outer diameter portion 176c on a side opposite to the injector body 171 (e.g., the lower side in FIG. 2).

Thus, as shown in FIG. 2, a step surface 176d is formed at a boundary between the large outer diameter portion 176b and the small outer diameter portion 176c. A tilt surface 176e is provided on the large outer diameter portion 176b at a position close to the injector body 171. The tilt surface 176e of the connection member 176 is configured such that the outer diameter of the tilt surface 176e is reduced as toward the injector body 171.

A tip portion 176f of the small outer diameter portion 176c is formed into a round shape by an orifice throttling. Therefore, the tip portion 176f of the small outer diameter portion 176c is adapted as a throttle portion.

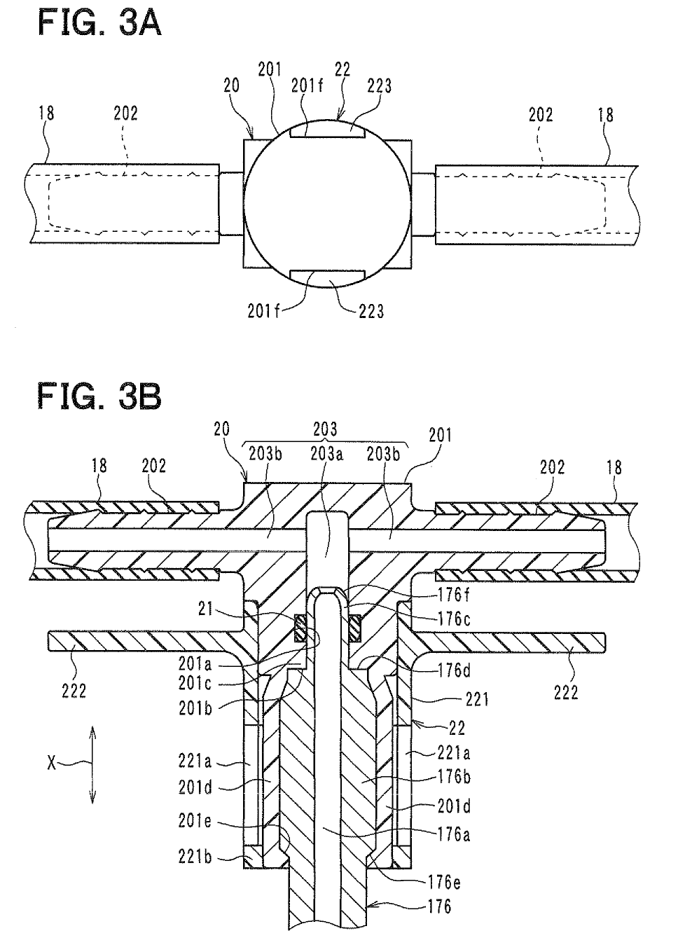

FIG. 3A is a top view showing a connection structure between the connection member 176 and the low pressure fuel pipe 18, and FIG. 3B is a cross-sectional view of the connection structure between the connection member 176 and the low pressure fuel pipe 18.

The connector 20, for connecting the connection member 176 and the low pressure fuel pipe 18, is integrally formed by using a resin. When the bio-fuel is used as the fuel, the connector 20 is made of a resin material superior in resistant to the bio-fuel, such polyphenylene sulfide (PPS), polyphtalamide (PPA) or the like.

The connector 20 includes a first connection portion 201 connected to the connection member 176, and a second connection portion 202 connected to the low pressure fuel pipe 18. The first connection portion 201 is provided to extend in a direction parallel with the axial direction X, and the second connection portion 202 is provided to extend in a direction perpendicular to the axial direction X.

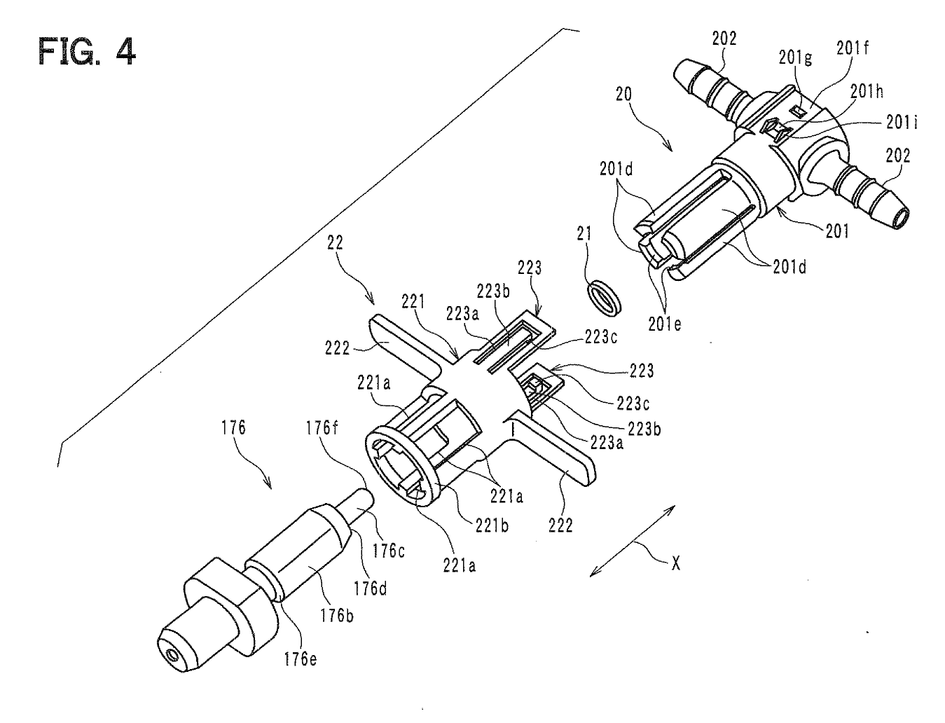

As shown in FIGS. 3A, 3B and 4, because two low pressure fuel pipes 18 are connected to the connector 20, two second connection portions 202 are provided in the connector 20 to correspond to the two low pressure fuel pipes 18. The two second connection portions 202 extend from an end portion of the first connection portion 201 to be opposite to each other, so that the connector 20 is formed into approximately a T-shape, as shown in FIG. 3B.

An approximately T-shaped through hole 203 is provided within the connector 20 to communicate with the fuel passage 176a of the connection member 176 and each low pressure fuel pipe 18. For example, the through hole 203 is configured by a cylindrical first hole portion 203a extending in a direction parallel to the axial direction within the first connection portion 201, and two cylindrical second hole portions 203b provided in the two second connection portions 202 to extend in direction perpendicular to the axial direction X and to communicate with the first hole portion 203a.

In the example of FIG. 3B, a rubber hose may be used as the low pressure fuel pipe 18. The two second connection portions 202 are respectively inserted into the two low pressure fuel pipes 18, to be connected to the two low pressure fuel pipes 18, respectively.

As shown in FIG. 1, the rightmost connector 20 among the four connectors 20 is connected to only one low pressure fuel pipe 18. In this case, only one second connection portion 202 is provided in the connector 20. For example, when the second connection portion 202 extends in a direction perpendicular to the axial direction X, the connector 20 is formed approximately into a L-shape entirely. Alternatively, when the second connection portion 202 extends in a direction parallel with the axial direction X, the connector 20 is formed approximately into a I-shape entirely. That is, the one second connection portion 202 may be provided in the connector 20 to extend in a direction substantially perpendicular to the axial direction X or a direction parallel to the axial direction X or a direction bent from the axial direction X, without being limited to the two second connection portions 202 shown in FIG. 36.

As shown in FIG. 3B, the small outer diameter portion 176c of the connection member 176 is inserted into the first hole portion 203a of the through hole 203. Therefore, the first hole portion 203a of the through hole 203 is adapted as an insertion hole into which the connection member 176 is inserted.

A circular O-ring recess portion 201a is provided in the inner peripheral surface of the first connection portion 201 defining the first hole portion 203a. An O-ring 21 is disposed in the O-ring recess portion 201a between the inner peripheral surface of the first connection portion 201 defining the first hole portion 203a and an outer peripheral surface of the small outer-diameter portion 176c of the connection member 176, to liquid-tightly seal therebtween.

A contact surface 201b is provided in the first connection portion 201 at a peripheral portion of the inlet opening portion of the first hole portion 203a, to contact the step surface 176d of the connection member 176. A circular protrusion portion 201c is configured by a portion of the first connection portion 201, positioned between the O-ring recess portion 201a and the contact surface 201b. The circular protrusion portion 201c is configured to protrude radially inside from the bottom surface of the O-ring recess portion 201a

A plurality of protrusion pieces 201d are provided in the first connection portion 201 of the connector 20. The protrusion pieces 201d are provided to extend from a peripheral portion of the contact surface 201b toward the other side opposite to the O-ring recess portion 201a in the axial direction X. In the example of FIGS. 3B and 4, four protrusion pieces 201d are provided to extend toward the connection member 176 in the connection direction (e.g., lower side in FIG. 3B). Each of the protrusion pieces 201d has a circular arc shape in a cross section that is perpendicular to the axial direction X. The circular arc shape of each protrusion piece 201d is provided along the outer peripheral surface of the large outer-diameter portion 176b of the connection member 176.

A claw portion 201e is provided at a protrusion tip end of each protrusion piece 201d to be engaged with a tilt surface 176e of the connection member 176. The claw portions 201e of the protrusion pieces 201d of the connector 20 are respectively engaged with the tilt surface 176e of the connection member 176, thereby preventing the connection member 176 from being removed from the connector 20.

A connector cover 22 is disposed to cover an outer peripheral surface of the first connection portion 201 of the connector 20. The connector cover 22 is disposed to be slidable in the axial direction X so as to be switched between a release state and a lock state. In the release state of the connector cover 22, a connection between the connector 20 and the connection member 176 is released. In contrast, in the lock state of the connector cover 22, a connection between the connector 20 and the connection member 176 is maintained and is locked.

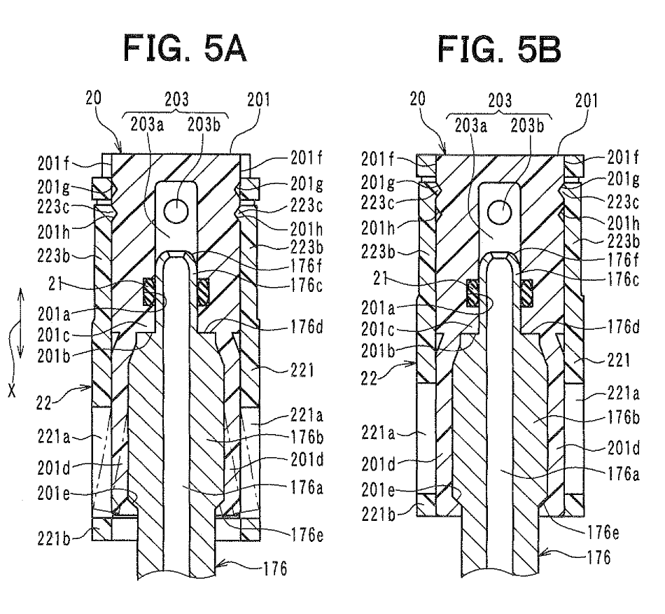

For example, when the connector cover 22 is moved to a lock position on a first side of the connector 20 in the axial direction X as shown in FIG. 5B, the connection between the connector 20 and the connection member 176 is locked. In contrast, when the connector cover 22 is moved to a release position on a second side of the connector 20, opposite to the first side in the axial direction X as shown in FIG. 5A, the connection between the connector 20 and the connection member 176 is released. Here, the first side of the connector 20 in the axial direction X corresponds to the side of the connector 20 in the connection direction between the connector 20 and the connection member 176, and the second side of the connector 20 in the axial direction X corresponds to the side of the connection member 176 in the connection direction between the connector 20 and the connection member 176.

As shown in FIG. 4, the connector cover 22 includes a cylindrical portion 221 extending in the axial direction X, two finger portions 222 (knob portions) protruding radially outside from an outer peripheral surface of the cylindrical portion 221, and two plate portions 223 protruding from one axial end of the cylindrical portion 221 to the first side in the axial direction X. The connector cover 22 including the cylindrical portion 221, the two finger portion 222 and the two plate portions 223 are molded integrally by using a resin.

The two finger portions 222 protrude from an outer peripheral surface of the cylindrical portion 221 to opposite sides in a radial direction. When a user moves the connector cover 22 in the axial direction X, the user can hold the finger portions 222 by the fingers. Thus, the moving operation of the connector cover 22, including the switching operation between the release state and the lock state, can be easily performed.

The other end portion of the outer peripheral surface of the cylindrical portion 221 in the axial direction X is provided with plural rectangular opening portions 221a.

The opening portions 221a are provided at plural positions respectively corresponding to the protrusion pieces 201d of the connector 20. In the example of FIG. 4, four opening portions 221a are provided. A circular portion 221b is provided at a tip end of the cylindrical portion 221 on a side adjacent to the opening portions 221a.

As shown in FIGS. 3A and 4, each of the plate portions 223 is provided to be received in a concave portion 201f provided on the outer surface of the first connection portion 201 of the connector 20. As shown in FIG. 4, a U-shape through groove 223a is formed in each plate portion 223, so as to form an elastic piece 223b formed by the U-shape through groove 223a. Therefore, the elastic piece 223b extends from one end portion of the cylindrical portion 221 to be deformable in the thickness direction (i.e., radial direction of the cylindrical portion 221).

A claw portion 223c is provided at a tip end of the elastic piece 223b to protrude radially inside of the elastic piece 223b. Furthermore, a first recess portion 201g and a second recess portion 201h are provided in the concave portion 201f, so that the claw portion 223c of the elastic piece 223b is capable of engaging with the first recess portion 2019 or the second recess portion 201h.

When the connector cover 22 is moved to the release position shown in FIG. 5A, the claw portion 223c of each elastic piece 223b is engaged with the second recess portion 201h. At the release position of the connector cover 22, the opening portions 221a of the connector 20 are respectively fitted with the protrusion pieces 201d, but the circular portion 221b of the connector cover 22 is not fitted with the protrusion pieces 201d of the connector 20.

When the connector cover 22 is moved to the lock position shown in FIG. 5B, the claw portion 223c of each elastic piece 223b is engaged with the first recess portion 211g. At the lock position of the connector cover 22, the opening portions 221a of the connector 20 are respectively fitted with the protrusion pieces 201d, and the circular portion 221b of the connector cover 22 is fitted with the protrusion pieces 201d of the connector 20. That is, the circular portion 221b of the connector cover 22 is fitted with the claw portions 201e of the protrusion pieces 201d of the connector 20.

Protrusion portions 201i are provided in the concave portion 201f of the connector 20, to be inserted into the through groove 223a of the connector cover 24. Because the protrusion portions 201i are slidably inserted into the through groove 223a of the connector cover 22, the movement of the connector cover 22 in the axial direction X can be guided.

Next, connection steps of the injector 17 and the low pressure fuel pipe 18 will be described.

First, the second connection portion 202 of the connector 20 is inserted into the end portion of the low pressure fuel pipe 18, so that the connector 20 and the low pressure fuel pipe 18 are connected to each other.

Next, the connector cover 22 is connected to the connector 20 to be located at the release position shown in FIG. 5A, and then the connection member 176 of the injector 17 is inserted into the first hole portion 203a as the insertion hole. At this time, the claw portions 201e of the protrusion pieces 201d of the connector 20 are located at positions interfering with the large outer diameter portion 176b of the connection member 176.

However, as in the chain line in FIG. 5A, because the protrusion pieces 201d of the connector 20 can be press-expanded from a side of the large outer diameter portion 176b of the connection member 176 toward the opening portions 221a of the connector cover 22, it is possible to insert the connection member 176 into the first hole portion 203a as the insertion hole.

In the present embodiment, the tip portion 176f of the small outer diameter portion 176c of the connection member 176 of the injector 17 is formed into the round shape by the orifice throttling. Thus, when the connection member 176 is inserted into the first hole portion 203a having the O-ring 22, it can prevent a damage of the O-ring 22 even when the small outer diameter portion 176c passes through the arrangement portion of the O-ring 22 in the first hole portion 203a as the insertion hole.

The connection member 176 is further inserted into the first hole portion 203a of the connector 20, so that the step surface 176d of the connection member 176 contacts the contact surface 201b of the connector 20. Then, the connector cover 22 is moved from the release position in FIG. 5A to the lock position in FIG. 5B, so that the circular portion 221b of the connector cover 22 is fitted with the claw portions 201e of the protrusion pieces 201d of the connector 20.

At the lock position shown in FIG. 5B, because the claw portions 201e of the protrusion pieces 201d of the connector 20 are engaged with the tilt surface 176e of the connection member 176 while it can prevent the protrusion pieces 201d of the connector 20 from being elastically deformed, the connection member 176 is not removed from the connector 20 so that the connection member 176 and the connector 20 becomes in the lock state.

With the above steps, the connection between the connection member 176 of the injector 17 and the connector 20 is ended, thereby finishing the connection between the injector 17 and the low pressure fuel pipe 18.

When the connection member 176 of the injector 17 and the low pressure fuel pipe 18 are disassembled, the connector cover 22 is moved from the lock position to the release position, and then the connection member 176 of the injector 17 is removed and separated from the connector 20.

At the connection state of the injector 17 and the low pressure fuel pipe 18, the low-pressure fuel flowing out from the fuel flow-out port 17c of the injector 17 flows into the low pressure fuel pipe 18 through the fuel passage 176a of the connection member 176 and the through hole 203 within the connector 20.

Because the throttle portion is provided at the tip portion 176f of connection member 176, the peak pressure in the pressure pulse of the fuel can be reduced.

In the present embodiment, the throttle portion for reducing the peak pressure in the pressure pulse of the fuel is provided in the connection member 176 of the injector 17, and thereby it is unnecessary to additionally provide a special throttle mechanism in the fuel injection device 10. Thus, components number can be reduced in the fuel injection device 10, thereby reducing the cost.

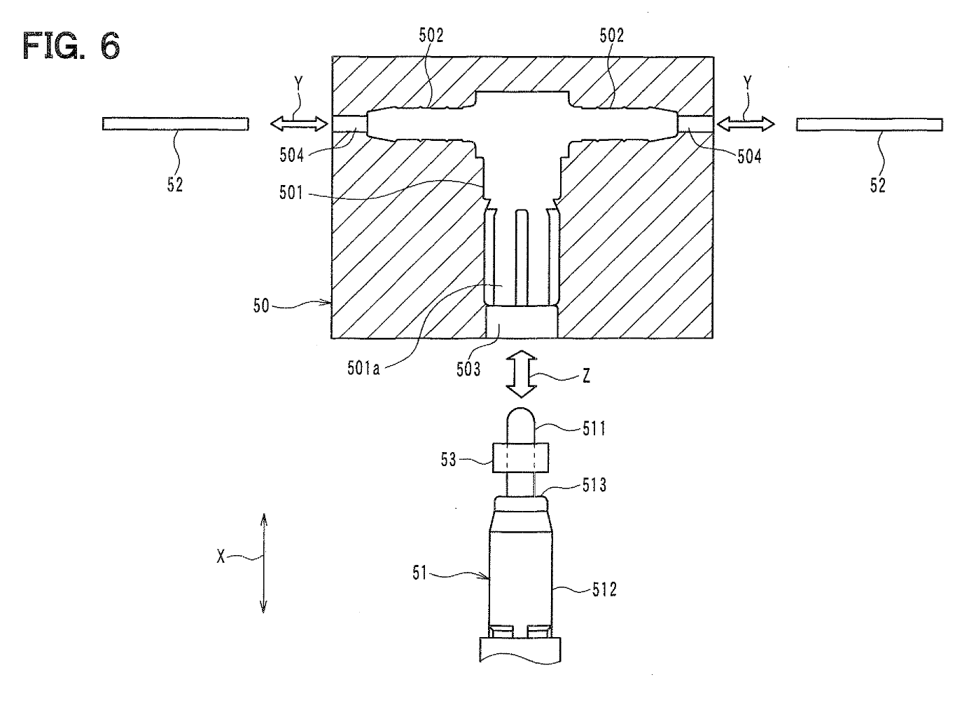

Next, a manufacturing method of the connector 20 will be described with reference to FIG. 6. The connector 20 is formed by an injection molding by using molding dies 50 to 53. In the example of FIG. 6, a forming die for molding the connector 20 is configured by a first molding die 50, a second molding die 51, a third molding die 52 and a core portion 53. The first molding die 50 is for molding outer shapes of the first and second connector portions 201 and 202 of the connector 20. The first molding die 50 can be divided into two molding die parts in the vertical direction of FIG. 6, at a position where the second connector portion 202 is provided.

The first molding die 50 includes a first molding portion 501 provided to correspond to the first connection portion 201 of the connector 20, and two second molding portions 502 provided to correspond to the two second connection portions 202 of the connector 20. The first molding portion 501 includes a protrusion piece molding portion 501a provided to mold the protrusion pieces 201d of the connector 20. A part of the protrusion piece molding portion 501a is configured by a slid core in order to be die-cut.

The first molding die 50 is provided with a first insertion portion 503 for inserting the second molding die 51 into the first molding portion 501, and a second insertion portion 504 for inserting the third molding die 52 into the second molding portion 502. In the example, two second insertion portions 504 are provided to insert the two third molding dies 52 into the second molding portions 502 via the two second insertion portions 504.

The second molding die 51 is inserted into the first molding portion 501 of the first molding die 50, so as to form a part of the inner shape of the connector 20. Specifically, the second molding die 51 includes a first cylindrical portion 511 configured to correspond to the first hole portion (insertion hole) 203a of the through hole 203 (fuel passage) of the connector 20, a second cylindrical portion 512 configured to correspond to inner wall surfaces of the protrusion pieces 201d of the connector 20, and a step portion 513 configured to correspond to the contact surface 201b of the connector 20.

The third molding die 52 is a rob-shaped molding die that is inserted into the second molding portion 502 of the first molding die 50, so as to mold the second hole portion 203b of the connector 20, extending in a direction perpendicular to the axial direction X, in the molding. The direction shown by the arrow Y in FIG. 6 shows an insertion and separation direction of the third molding die 52 with respect to the first molding die 50.

The core portion 53 is inserted into the first molding portion 501 of the first molding die 50, together with the second molding die 51, so as to form the O-ring recess portion 201a of the connector 20. Specifically, the core portion 53 is formed into a circular cylindrical shape, and is inserted into the first molding portion 501 of the first molding die 50, in a state where the first cylindrical portion 511 of the second molding die 51 is inserted into an insertion hole of the core portion 53.

The direction shown by the arrow Z in FIG. 6 shows an insertion and separation direction of the second molding die 51 with respect to the first molding die 50. The O-ring recess portion 201a to be formed by the core portion 53 is recessed to a direction perpendicular to the insertion and separation direction Z of the second molding die 52, and becomes in an undercut shape in the molding.

Due to the undercut shape of the O-ring recess portion 201a in the molding, it is impossible to remove the core portion 53 from a molded product (i.e., molded connector). In the present embodiment, after the connector 20 including the core portion 53 is integrally molded, the core portion 53 is dissolved by a solvent, and thereby the core portion 53 is removed.

In the present embodiment, as the solvent, a chemical solvent such as a strong acid liquid (e.g., sulfuric acid liquid) or a strong alkali liquid or the like may be used. Thus, as the material of the core portion 53, aluminum, iron or the like, which can be easily dissolved by the chemical solvent such as the strong acid liquid or the strong alkali liquid, may be used.

When a strong acid liquid is used as the solvent, the core portion 53 is made of aluminum or iron which is easily dissolved by the strong acid liquid. When a strong alkali liquid is used as the solvent, the core portion 53 is made of aluminum which is easily dissolved by the strong alkali liquid.

As the material of the core portion 53, a resin material having a low resistance to chemicals and having a high melting point may be used. If the resin material for forming the core portion 53 has a low melting point, the core portion 53 may be melted in the molding. In the present embodiment, the insertion and separation direction Z of the second molding die 51 is parallel with the axial direction X.

Next, a molding process of the connector 20 using the molding dies 50 to 53 will be described. First, the molding dies 50 to 53 are set and clamped in a die clamping step. Specifically, the first cylindrical portion 511 of the second molding die 51 is inserted into an insertion hole of the core portion 53, the second molding die 51 and the core portion 53 are inserted integrally into the first molding portion 501 of the first molding die 50, and the third molding die 52 is inserted into the second molding portion 502 of the first molding die 50. The third molding die 52 is inserted into the first molding die 50 until the third molding die 52 contacts the first cylindrical portion 511 of the second molding die 51.

Next, a melted fluid resin is injected to a space defined by the first to third molding dies 50, 51, 52 and the core portion 53, and the injected resin is cooled in the molding die for a predetermined time, in a molding step.

Next, the first, second and third molding dies 50 to 52 are opened to be separated from the molded product, in a die separating step. Specifically, the first molding die 50 is divided into two parts in the top-bottom direction in FIG. 6 at a position where the second connection portion 202 is provided, and then the second and third molding dies 51, 52 are separated from the molded product (molded connector) having the core portion 53 therein.

The molded first and second connection portions 201, 202 removed from the molding die together with the core portion 53 is immersed in the solvent within a container for a predetermined time in a dissolving step, so as to dissolve and remove the core portion 53 in the molded product, thereby forming the connector 20.

Because the connector 20 is made of a resin material such as PPS or PPA, the connector 20 is superior in resistance to the bio-fuel and is also superior in resistance to chemicals, and thereby the connector 20 is not dissolved by the solvent in the dissolving step. Thus, when the dissolving of the core portion 53 in the connector 20 is ended, the manufacturing process of the connector 20 is finished.

In the present embodiment, because the O-ring recess portion 201a is recessed to radially outside from the peripheral surface of the insertion hole 203a, the O-ring recess portion 201a formed in the connector 20 becomes in an undercut shape in the molding. However, the core portion 53 for forming the O-ring recess portion 201a is dissolved by a solvent after molding. Thus, the O-ring recess portion 201a can be easily formed in the molded connector 20, thereby easily integrally molding the connector 20 having therein the O-ring recess portion 201a and the circular protruding portion 201c.

The circular protruding portion 201c may be molded separately from a connector having an O-ring recess portion 201a opened directly at the inlet opening of the first hole portion 203a. In this case, the O-ring recess portion 201a may be molded integrally with the connector without causing an undercut shape in the molding. However, in this case, it is necessary to hole the circular protruding portion 201c to the connector after the circular protruding portion 201c is separately molded from the connector, and thereby it is difficult to obtain the strength resisting to the fuel pressure with a small dimension of the connector.

In contrast, in the present embodiment, because the connector 20, provided with the O-ring recess portion 201a and the circular protruding portion 201c, is molded integrally, it is easy for the circular protruding portion 201c to have the strength resisting to the fuel pressure while the size of the connector 20 can be reduced.

In the present embodiment, because the connector 20 is made of a resin material such as PPS or PPA, which is superior in resistance to the bio-fuel and is also superior in resistance to chemicals, the connector 20 itself is not dissolved by the solvent in the dissolving step. Thus, the connector 20 can be suitably applied to a fuel injection device using the bio-fuel, and can be manufactured by dissolving the core portion 53 in chemical solvent such as a strong acid liquid or a strong alkali liquid.

### Other Embodiments

Although the present invention has been fully described in connection with the preferred embodiments thereof with reference to the accompanying drawings, it is to be noted that various changes and modifications will become apparent to those skilled in the art.

For example, in the above embodiment, the bio-fuel is used as the fuel; however, various-kinds fuels may be used as the fuel.

In the above-described embodiment, as shown in FIG. 6, the two second molding portions 502 and the two third molding dies 52 are adapted, so as to form the two second connection portion 202 in the connector 20. However, one second connection portion 502 may be provided in the first molding die 50, and one third molding die 52 may be provided to be inserted into one second insertion portion 504, so as to mold a connector 20 having a single first connection portion 201 and a single second connection portion 202. Even in this case, the first molding portion 501 of the first molding die 50, and the second molding die 51 can be formed similarly to FIG. 6, thereby obtaining the same effect described in the above embodiment.

The solvent for dissolving the core portion 53 is not limited to the strong acid liquid or the strong alkali liquid, but other solvent may be used. That is, if the material of the core portion 53 can be dissolved in a solvent but is not melted in the molding, any solvent can be used. As the material for forming the connector 20, any material, which can be melted in the molding but has a sufficient resistance to the solvent, can be suitably adapted.

In the above-described embodiment, the end portion of the second connection portion 202 is inserted into the low pressure fuel pipe 18, so that the low pressure fuel pipe 18 is connected to the second connection portion 202. However, the end portion of the low pressure fuel pipe 18 may be inserted into the second connection portion 202 so as to connect the low pressure fuel pipe 18 and the second connection portion 212, similarly to the connection between the connection member 176 and the first connection portion 201.

In the above-described embodiment, the manufacturing method of the present invention is typically applied to the connector 20 to be connected between an injector and a low pressure fuel pipe in a fuel injection device. However, the manufacturing method of the present invention can be applied to any connector 20 to be connected to a connection member for a fluid flow.

Such changes and modifications are to be understood as being within the scope of the present invention as defined by the appended claims.

What is claimed is:

1. A method of manufacturing a connector that includes a first connection portion to be connected to a connection member in which a fluid flows, and a second connection portion to be connected to a pipe member in which the fluid flows, the method comprising:
integrally molding the first and second connection portions with a resin, by using a first molding die having a molding portion for molding outer shapes of the first and second connection portions, a cylindrical second molding die inserted into the molding portion of the first molding die to mold a cylindrical insertion hole in which the connection member is inserted, and a circular core portion inserted into the molding portion together with the second molding die in a state where the second molding die is inserted into the core portion;
separating the first and second molding dies so as to remove the molded first and second connection portions together with the core portion from the first and second molding dies, after the integrally molding; and
dissolving the core portion in the first connection portion by using a solvent, so as to form a circular recess portion for arranging an O-ring, the recess portion being recessed from a peripheral surface of the insertion hole to a radial outside in the first connection portion.

2. The method of manufacturing a connector according to claim 1, wherein
the solvent is a strong acid liquid, and
the core portion is made of a material of aluminum or iron.

3. The method of manufacturing a connector according to claim 1, wherein
the solvent is a strong alkali liquid, and
the core portion is made of a material of aluminum.

4. The method of manufacturing a connector according to claim 1, wherein
the second molding die includes a cylindrical portion extending in an axial direction and inserted into a hole portion of the core portion at a position in the axial direction, and
the core portion is inserted into the molding portion of the first molding die together with the cylindrical portion of the second molding die, before the molding.

5. The method of manufacturing a connector according to claim 1, wherein
the molding portion of the first molding die for molding the outer shapes of the first and second connection portions includes a first molding part and a second molding part which are dividable from each other in the axial direction, at a position where the second connection portion is formed.

6. The method of manufacturing a connector according to claim 1, wherein
the connector is adapted for connecting the connection member for discharging a low pressure fuel from an injector for a fuel injection, to a low pressure fuel pipe.
